(19) United States
(12) Patent Application Publication
(10) Pub. No.: US 2023/0184515 A1
(43) Pub. Date: Jun. 15, 2023

(54) SURFACE-TO-AIR FLIGHT GUIDANCE APPARATUS

(71) Applicant: OWLYNK CO., LTD., Seongnam-si (KR)

(72) Inventor: Shin Hwan HWANG, Yongin-si (KR)

(73) Assignee: OWLYNK CO., LTD., Seongnam-si (KR)

(21) Appl. No.: 18/077,232

(22) Filed: Dec. 8, 2022

(30) Foreign Application Priority Data
Dec. 9, 2021 (KR) 10-2021-0175343

(51) Int. Cl. F41G 7/22; F42B 15/01; F41G 7/26

(52) U.S. Cl. CPC F41G 7/22; F42B 15/01; F41G 7/26; F41G 7/2286

(57) ABSTRACT

A flight guidance technique for guiding an aerial vehicle to track a target is provided. A flight guidance apparatus transmits a radio frequency (RF) signal encoded with transmission direction information to an antenna. A guided aerial vehicle receives RF signals transmitted through two antennas spaced apart from each other, measures a phase difference between the RF signals, and compares the measured phase difference with a result of decoding the transmission direction information to control a direction of flight.

### CROSS-REFERENCE TO RELATED APPLICATION(S)

This application claims priority from Korean Patent Application No. 10-2021-0175343, filed on Dec. 9, 2021, in the Korean Intellectual Property Office, the disclosure of which is incorporated herein by reference in its entirety.

### BACKGROUND

### 1. Field

The following description relates to an apparatus for guiding the flight of an aerial vehicle, and more particularly, to a technique for guiding an aerial vehicle to track a target.

### 2. Description of Related Art

Korean Patent No. 10-1802873, filed on Apr. 10, 2017 and registered on Nov. 23, 2017, discloses a technique for obtaining information about a target from a radar signal, allowing a target tracker to emit a laser signal toward the target, and allowing an guided aerial vehicle to receive a laser signal reflected from the target, thereby maintaining target tracking. When the guided aerial vehicle fails to receive the reflected laser signal, the technology allows the guided aerial vehicle to emit a radio frequency (RF) signal toward the target through a signal emitter and receive a reflected wave from the target to maintain target tracking. The technology is based on the reception of a reflected wave of a laser signal from the guided aerial vehicle and thus the reliability of tracking a target by the guided aerial vehicle is inevitably less than the reliability of tracking the target by the target tracker. In addition, in order to compensate for this problem, the guided aerial vehicle should be equipped with a target tracking system.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The following description is directed to providing a flight guidance system having a simple structure.

The following description is also directed to providing a flight guidance system having a simple and inexpensive structure and high reliability.

The following description is also directed to providing a flight guidance system that is easy to control or operate.

In a general aspect, a flight guidance apparatus transmits a radio frequency (RF) signal encoded with transmission direction information to an antenna. The guided aerial vehicle controls a direction of flight by receiving RF signals, measuring a phase difference between the RF signals, and comparing the measured phase difference with decoded transmission direction information.

In an additional aspect, the flight guidance apparatus may include a horizontal transmission antenna including two antennas installed to be spaced apart from each other in a direction parallel to the ground, and a vertical transmission antenna including two antennas provided with the same transmission axis as the horizontal transmission antenna and installed to be spaced apart from each other in a direction perpendicular to the ground.

In an additional aspect, the flight guidance apparatus may detect a target and control directions of the transmission antennas to face the target.

Other features and aspects will be apparent from the following detailed description, the accompanying drawings, and the claims.

### BRIEF DESCRIPTION OF THE DRAWINGS

FIG. 1 illustrates a flight guidance apparatus and a guided aerial vehicle according to an embodiment;

FIG. 2 is a block diagram illustrating a configuration of a flight guidance apparatus according to an embodiment; and

FIG. 3 is a block diagram illustrating a configuration of a guided aerial vehicle according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The foregoing and further aspects will be implemented through embodiments described with reference to the accompanying drawings. It should be understood that components of each embodiment can be implemented in various combinations therein or with those of other embodiments, unless mentioned otherwise and as long as there is no contradiction between components. The terms used in the present specification and the claims should be interpreted as meanings and concepts in accordance with the description herein or the proposed technical idea, based on the principle that the inventors can appropriately define the concept of the terms to describe the present disclosure in the best way. Hereinafter, embodiments of the present disclosure will be described in detail with reference to the accompanying drawings.

In an aspect, a flight guidance apparatus transmits a radio frequency (RF) signal encoded with transmission direction information to an antenna. The guided aerial vehicle controls a direction of flight by receiving RF signals, measuring a phase difference between the RF signals, and comparing the measured phase difference with decoded transmission direction information.

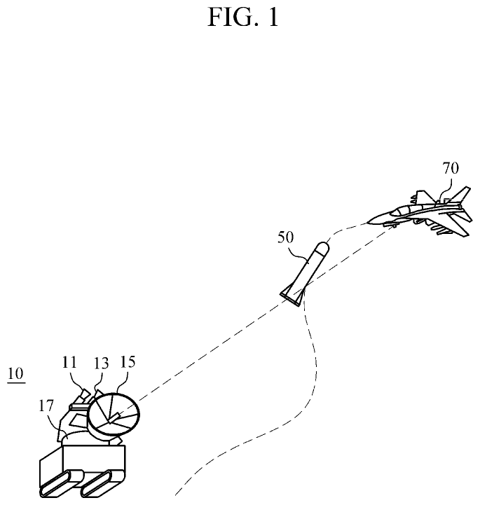

FIG. 1 illustrates a flight guidance apparatus and a guided aerial vehicle according to an embodiment. A flight guidance apparatus 10 guides the flight of a guided aerial vehicle 50, e.g., missile, fired to shoot down a target 70, e.g., a fighter. The guided aerial vehicle 50 is fired from a launcher, and then tracks and strikes the target 70 according to a guide signal from the flight guidance apparatus 10. In an embodiment, the flight guidance apparatus 10 includes a transmission antenna 15. An auto-pilot system of the guided aerial vehicle 50 is guided to fly toward the target 70 according to an RF signal transmitted through the transmission antenna 15. A wireless transmission circuit is mounted in the flight guidance apparatus 10 to supply an RF signal to the transmission antenna 15. In an embodiment, a guide signal from the flight guidance apparatus 10 is always transmitted toward the target 70. The transmission antenna 15 for transmitting the guide signal is mounted on a gimbal 17 to maintain a direction toward the target 70. The flight guidance apparatus 10 may further include a target detection sensor such as a camera 11 or a radar 13 to identify a direction of the target 70 and control the gimbal 17.

The transmission antenna 15 includes at least two omni-directional antennas spaced a certain distance from each other. In a directional communication method according to an aspect, an RF signal transmitted from a transmitter includes transmission direction information. In an embodiment, the transmission direction information is phase difference information of a receiver that will receive the transmitted RF signals. The receiver receives the RF signals and decodes the phase difference information. Meanwhile, the receiver measures a phase difference between two RF signals received from two omni-directional antennas. The receiver determines that the transmitter has accessed desired communication when a result of comparing the measured phase difference with the decoded phase difference information reveals that the differences are the same. Trajectories with the same phase difference at dipoles of two antennas spaced apart from each other form a hyperbola. That is, phase differences measured by two receivers on the hyperbola have the same value. A directional communication method using such an omni-directional antenna is disclosed in Korean Patent Application No. 10-2021-0125699 filed on Sep. 23, 2021 by the present applicant.

In this method, a transmitter does not necessarily have to transmit an RF signal, which includes encoded information about a phase difference, only in a direction corresponding to the phase difference. Even when the transmitter transmits RF signals in all directions, a receiver may measure a phase difference and selectively respond to an instantaneous RF signal containing phase difference information corresponding to the measured phase difference, thereby achieving the directionality of communication. In this case, the transmitter may sequentially encode and transmit values obtained by dividing the phase difference by a predetermined number within a certain range.

To distinguish between RF signals transmitted through at least two omni-directional antennas spaced a certain distance from each other, the transmitter may sequentially transmit RF signals through the at least two antennas in a time division manner. As another example, the transmitter may change a carrier frequency for modulation of RF signals transmitted through the at least two antennas.

According to an additional aspect, the flight guidance apparatus 10 may further include target detection sensors, and the gimbal 17. The flight guidance apparatus 10 detects a direction of a target through the target detection sensors, and controls the gimbal 17 to cause the transmission antenna 15 mounted on the gimbal 17 to face the target. The target detection sensors may include the camera 11. As another example, the target detection sensors may further include the radar 13. The transmission antenna 15 is mounted on the gimbal 17, and the radar 13 and the camera 11 may be additionally mounted thereon. The camera 11 may not be mounted on the gimbal 17 but may be mounted on a frame of the flight guidance apparatus 10 to detect a target in a wide area.

The embodiment of FIG. 1 illustrates an example of a flight guidance apparatus equipped with an auto tracking device for guiding the flight of a guided aerial vehicle mounted on a vehicle to track a target, but the present disclosure is not limited thereto. For example, the flight guidance apparatus 10 may be in the form of a handgun equipped with an antenna. In order to guide the flight of a guided aerial vehicle, a person may move toward a target while holding the flight guidance apparatus 10.

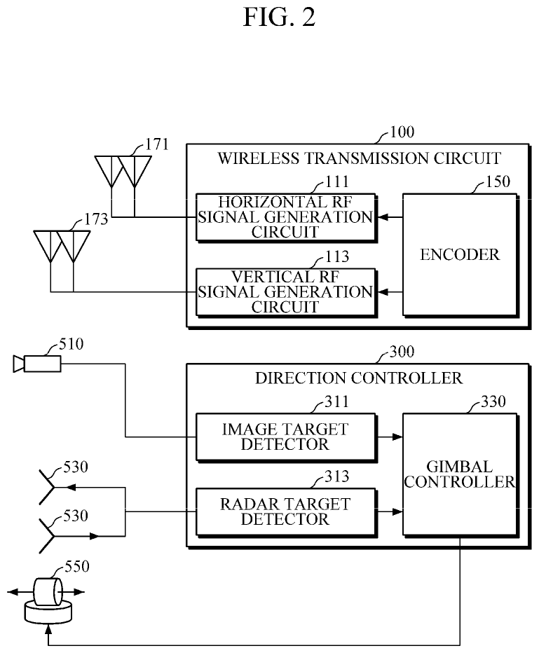

FIG. 2 is a block diagram illustrating a configuration of a flight guidance apparatus according to an embodiment. As shown in FIG. 2, the flight guidance apparatus according to the embodiment includes a transmission antenna 171 and a wireless transmission circuit 100. The transmission antenna 171 includes at least two antennas spaced apart from each other and configured to transmit an RF signal.

In the illustrated embodiment, the transmission antenna includes a horizontal transmission antenna 171 and a vertical transmission antenna 173 each including two antennas. The horizontal transmission antenna 171 includes two antennas installed to be spaced apart from each other in a direction parallel to the ground. The vertical front antenna 173 includes at least two antennas having the same transmission axis as the horizontal front antenna 171 and spaced apart from each other in a direction perpendicular to the ground. A directional communication method using two antennas spaced apart from each other has been described above and thus a detailed description thereof will be omitted.

The wireless transmission circuit 100 generates at least one RF signal encoded with transmission direction information based on the transmission axis to the transmission antennas. In the illustrated embodiment, the wireless transmission circuit 100 includes a horizontal RF signal generation circuit 111, a vertical RF signal generation circuit 113, and an encoder 150. The encoder 150 provides phase difference information in a horizontal direction and a vertical direction for a guided aerial vehicle to follow. The phase difference may be 0 degrees in both the horizontal and vertical directions. However, the present disclosure is not limited thereto, and the phase difference may be a fixed value or a value that varies according to the position of a target. The horizontal RF signal generation circuit 111 transmits an RF signal, which is encoded with a phase difference value input from the encoder 150, through the two antennas of the horizontal transmission antenna 171 that are spaced apart from each other. The vertical RF signal generation circuit 113 transmits an RF signal, which is encoded with a phase difference value input from the encoder 150, through the two antennas of the vertical transmission antenna 173 that are spaced apart from each other.

According to an additional aspect, the flight guidance apparatus may detect a target and control the directions of the transmission antennas 171 and 173 to face the target. In the illustrated embodiment, the flight guidance apparatus may further include target detection sensors, a gimbal 550, and a direction controller 300. In an embodiment, the target detection sensor may include a camera 510. The gimbal 550 may be a biaxial gimbal for controlling the elevation and azimuth angles of the mounted transmission antennas 171 and 173. The direction controller 300 identifies a direction of a target from signals output from the target detection sensors and drives the gimbal 550 to cause the transmission antennas 171 and 173 to face the target. Technology for detecting a target region of an image output from the camera 510 and determining an absolute direction, i.e., an azimuth angle and an elevation angle, from the coordinates of pixels of the target region is known in the field of target tracking.

In an embodiment, the target detection sensors further include a radar sensor 530. In the embodiment, not only the transmission antennas 171 and 173 but also the radar sensor 530 may be further mounted on the gimbal 550. The radar sensor 530 may be a multi-channel radar that includes a plurality of transmission antennas and a plurality of reception antennas to detect a position of a target in the horizontal and vertical directions. In an embodiment, the direction controller 300 includes an image target detector 311 and a radar target detector 313. The image target detector 311 calculates and outputs an azimuth angle and an elevation angle of a target from an image output from the camera 510. A gimbal controller 330 drives the gimbal 550 according to the azimuth and elevation angles. The radar target detector 313 may detect an azimuth angle and an elevation angle of a target with improved reliability according to a signal received from the radar 530 mounted on the gimbal 550. The gimbal controller 330 may finely control the gimbal 550 according to the azimuth and elevation angles of a target output from the radar target detector 313.

In the embodiment of FIG. 2, all or some of the image target detector 311, the radar target detector 313, and the gimbal controller 330 may represent a functional group of program instructions stored in a memory and read and executed by a microprocessor. Technology for implementing such functions is possible in various combinations including circuits, a general-purpose processor, a signal processing processor, a dedicated semiconductor circuit, a semiconductor gate array, and the like and thus a detailed description will be omitted here.

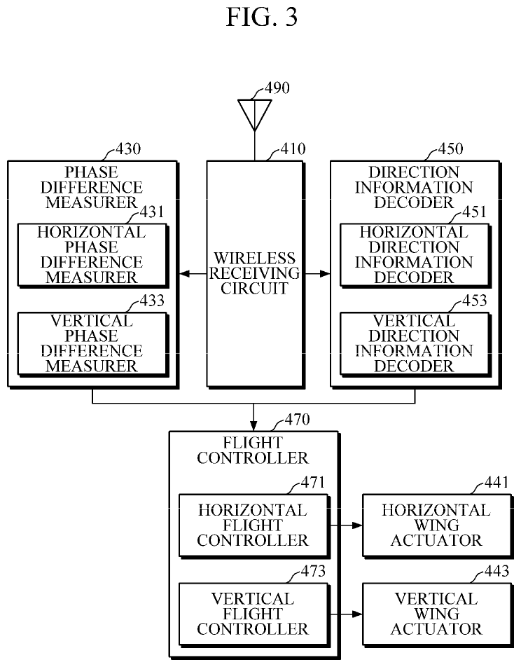

FIG. 3 is a block diagram illustrating a configuration of a guided aerial vehicle according to an embodiment. In the embodiment, the guided aerial vehicle includes a reception antenna 490, a wireless receiving circuit 410, a phase difference measurer 430, a direction information decoder 450, and a flight controller 470.

The reception antenna 490 receives RF signals transmitted through at least two transmission antennas spaced apart from each other. The RF signals transmitted through the two transmission antennas may be distinguished from each other in terms of time or frequency. The wireless receiving circuit 410 demodulates RF signals received through the reception antenna 490. The phase difference measurer 430 measures a phase difference between RF signals transmitted through the two transmission antennas, which are spaced apart from each other, from the RF signals received through the reception antenna 490. The phase difference may be measured from an intermediate frequency signal or a demodulated baseband signal. The direction information decoder 450 decodes transmission direction information included in an RF signal received through the reception antenna 490. In an embodiment, the transmission direction information may be obtained by cutting a corresponding information region of a base signal demodulated by the wireless receiving circuit 410 and decoding the corresponding information region. In an embodiment, the transmission direction information is phase difference information.

The flight controller 470 controls a direction of flight by reflecting a result of comparison between a phase difference measured by the phase difference measurer 430 and transmission direction information decoded by the direction information decoder 450. In an embodiment, the flight controller 470 controls a direction of flight such that the phase difference measured by the phase difference measurer 430 matches phase difference information decoded by the direction information decoder 450. That is, when a phase difference measured at a first position by the phase difference measurer 430 is different from phase difference information decoded by the direction information decoder 450, a process of comparing a phase difference measured at a second position by the phase difference measurer 430 with the phase difference information decoded by the direction information decoder 450 is repeatedly performed several times to determine whether a difference between a phase difference and the decoded phase difference information is less than a previous difference and to change a direction of flight to reduce the difference.

In the illustrated embodiment, the phase difference measurer 430 may include a horizontal phase difference measurer 431 and a vertical phase difference measurer 433. The horizontal phase difference measurer 431 measures a phase difference between at least two horizontal RF signals in a direction parallel to the ground. The vertical phase difference measurer 433 measures a phase difference between at least two vertical RF signals in a direction perpendicular to the ground. In this case, a transmission antenna includes two antennas arranged parallel to the ground and two antennas arranged perpendicular to the ground.

In the illustrated embodiment, the direction information decoder 450 includes a horizontal direction information decoder 451 and a vertical direction information decoder 453. The horizontal direction information decoder 451 decodes horizontal direction information included in a horizontal RF signal. The vertical direction information decoder 453 decodes vertical direction information included in a vertical RF signal. In an embodiment, the horizontal transmission direction information and vertical transmission direction information may be obtained by cutting and decoding corresponding information regions of base signals demodulated by the wireless receiving circuit 410. Each RF signal may be transmitted through a transmission antenna in a time division manner and sequentially demodulated and buffered by the wireless receiving circuit 410. In an embodiment, the transmission direction information is phase difference information.

In the illustrated embodiment, the flight controller 470 includes a horizontal flight controller 471 and a vertical flight controller 473. The horizontal flight controller 471 controls horizontal flight by reflecting a result of comparison between a horizontal direction phase difference and horizontal direction information. The vertical flight controller 473 controls vertical flight by reflecting a result of comparison between a vertical direction phase difference and vertical direction information. A guided aerial vehicle may be, for example, a missile. In an embodiment, a guided aerial vehicle, e.g., a missile, may be controlled to turn left or right by tilting a pair of wings facing each other in the vertical direction among the four wings of the missile in the same direction with respect to an axis of symmetry. Similarly, the guided aerial vehicle, e.g., a missile, may be controlled to move upward or downward by tilting a pair of wings facing each other in the horizontal direction among the four wings of the missile in the same direction with respect to an axis of symmetry. By tilting the four wings in opposite directions with respect to the axis of symmetry, the body of the guided aerial vehicle may be controlled to roll clockwise or counterclockwise.

The flight controller 470 may control flight such that a phase difference measured by the phase difference measurer 430 is the same as transmission direction information decoded by the direction information decoder 450, that is, the transmission direction information converges to a direction of a transmission axis.

All or some of the block illustrated in the embodiment of FIG. 3 may represent a functional group of program instructions stored in a memory and read and executed by a microprocessor. Technology for implementing such functions is possible in various combinations including circuits, a general-purpose processor, a signal processing processor, a dedicated semiconductor circuit, a semiconductor gate array, and the like and thus a detailed description will be omitted here.

According to the present disclosure, the flight of a guided aerial vehicle configured to strike an aerial vehicle such as a drone can be guided using a wireless transmission device with two antennas. When a flight guidance apparatus is manufactured as a portable type, the flight of a guided aerial vehicle can be guided using a simple configuration of a wireless transmitter.

While the present disclosure has been described above with respect to embodiments in conjunction with the accompanying drawings, the present disclosure is not limited thereto and should be interpreted to cover various modifications that will be apparent to those of ordinary skill in the art. The claims are intended to cover such modifications.

What is claimed is:

1. A flight guidance apparatus comprising:
a transmission antenna including at least two antennas spaced apart from each other to transmit a radio frequency (RF) signal; and
a wireless transmission circuit configured to generate at least one RF signal encoded with transmission direction information based on a transmission axis of the transmission antenna and supply the at least one RF signal to the transmission antenna.

2. The flight guidance apparatus of claim 1, wherein the transmission antenna comprises:
a horizontal transmission antenna including two antennas installed to be spaced apart from each other in a direction parallel to the ground; and
a vertical transmission antenna including two antennas provided with the same transmission axis as the horizontal transmission antenna and installed to be spaced apart from each other in a direction perpendicular to the ground,
wherein the wireless transmission circuit generates RF signals encoded with the transmission direction information based on the transmission axis and supplies the RF signals to the horizontal transmission antenna and the vertical transmission antenna.

3. The flight guidance apparatus of claim 1, further comprising:
a target detection sensor;
a gimbal on which the transmission antenna is mounted; and
a direction controller configured to identify a direction of a target from a signal output from the target detection sensor and drive the gimbal to cause the transmission antenna to face the target.

4. The flight guidance apparatus of claim 3, wherein the target detection sensor comprises:
a camera; and
a radar mounted on the gimbal.

5. A guided aerial vehicle compressing:
a reception antenna configured to receive radio frequency (RF) signals transmitted from at least two transmission antennas spaced apart from each other;
a wireless receiving circuit configured to demodulate the RF signals received by the reception antenna;
a phase difference measurer configured to measure a phase difference between the RF signals received by the reception antenna, wherein the RF signals are transmitted from the at least two transmitting antennas, respectively;
a transmission direction information decoder configured to decode transmission direction information in the RF signals received by the reception antenna; and
a flight controller configured to control a direction of flight by reflecting a result of comparison between the phase difference measured by the phase difference measurer and the transmission direction information decoded by the transmission direction information decoder.

6. The guided aerial vehicle of claim 5, wherein the phase difference measurer comprises:
a horizontal phase difference measurer configured to measure a phase difference between at least two horizontal RF signals in a direction parallel to the ground; and
a vertical phase difference measurer configured to measure a phase difference between at least two vertical RF signals in a direction perpendicular to the ground,
the transmission direction information decoder comprises:
a horizontal direction information decoder configured to decode horizontal direction information in a horizontal RF signal; and
a vertical direction information decoder configured to decode vertical direction information in a vertical RF signal, and
the flight controller comprises:
a horizontal flight controller configured to control horizontal flight by reflecting a result of comparison between a horizontal direction phase difference and horizontal direction information; and
a vertical flight controller configured to control vertical flight by reflecting a result of comparison between a vertical direction phase difference and vertical direction information.

7. The guided aerial vehicle of claim 5, wherein the flight controller controls flight to cause the measured phase difference to be the same as the decoded transmission direction information and the transmission direction information to converge to a direction of a transmission axis.
